(19) United States
(12) Patent Application Publication
(10) Pub. No.: US 2022/0139078 A1
(43) Pub. Date: May 5, 2022

(54) UNMANNED AERIAL VEHICLE, COMMUNICATION METHOD, AND PROGRAM

(71) Applicant: Sony Group Corporation, Tokyo (JP)

(72) Inventor: Sho MURAKOSHI, Tokyo (JP)

(73) Assignee: Sony Group Corporation, Tokyo (JP)

(21) Appl. No.: 17/428,984

(22) PCT Filed: Jan. 30, 2020
(86) PCT No.: PCT/JP2020/003349

§ 371 Date: Aug. 6, 2021

(30) Foreign Application Priority Data
Feb. 13, 2019 (JP) 2019-023216

(51) Int. Cl. G06V 20/17; G06V 20/10; G06T 7/73; G08G 5/00; B64D 47/08; B64C 39/02

(52) U.S. Cl. CPC G06V 20/17; G06V 20/176; G06V 20/188; G06T 7/73; G08G 5/003; G08G 5/0069; B64C 2201/127; B64D 47/08; B64C 39/024; G06T 2207/10032; G06T 2207/30184; G06T 2207/30188; B64C 2201/123; G08G 5/0091

(57) ABSTRACT

The present disclosure relates to an unmanned aerial vehicle, a communication method, and a program capable of more accurately identifying an identification target.

A communication unit receives identifier information regarding an identifier corresponding to context information of flight, and a control unit extracts feature information by using the identifier information from sensor data acquired by a sensor mounted on an unmanned aerial vehicle. Further, the communication unit transmits the extracted feature information to a server. The technology according to the present disclosure is applicable to a drone.

### TECHNICAL FIELD

The present disclosure relates to an unmanned aerial vehicle, a communication method, and a program, and more particularly relates to an unmanned aerial vehicle, a communication method, and a program capable of more accurately identifying an identification target.

### BACKGROUND ART

In recent years, a captured image obtained by capturing an image of a ground control point with a camera mounted on a drone is used to conduct topographic surveys, inspection of structures, and the like.

In order to accurately detect a ground control point from a captured image, Patent Document 1 discloses a technology of extracting a feature value of a candidate area including a ground control point from a captured image in which the ground control point appears and identifying the ground control point on the basis of the extracted feature value.

### CITATION LIST

### Patent Document

Patent Document 1: WO 2018/123607 A

### SUMMARY OF THE INVENTION

### Problems to be Solved by the Invention

Because drones are used as general-purpose robots in recent years, there are various contexts (flight purpose, flight environment, and the like) for sensing a target by their flight. Therefore, a target to be sensed may not be accurately identified depending on a context.

The present disclosure has been made in view of such a situation, and an object thereof is to more accurately identify an identification target.

### Solutions to Problems

An unmanned aerial vehicle according to the present disclosure serving as an unmanned aircraft includes: a control unit that extracts feature information from sensor data acquired by a sensor mounted on the unmanned aircraft; and a communication unit that transmits the extracted feature information to a server, in which: the communication unit receives identifier information regarding an identifier corresponding to context information of flight; and the control unit extracts the feature information from the sensor data by using the identifier information.

A communication method according to the present disclosure includes: causing an unmanned aerial vehicle to receive identifier information regarding an identifier corresponding to context information of flight, extract feature information from sensor data acquired by a sensor mounted on the unmanned aircraft by using the identifier information, and transmit the extracted feature information to a server.

A program according to the present disclosure is a program for causing a computer to execute the processing of receiving identifier information regarding an identifier corresponding to context information of flight, extracting feature information from sensor data acquired by a sensor mounted on an unmanned aerial vehicle by using the identifier information, and transmitting the extracted feature information to a server.

In the present disclosure, identifier information regarding an identifier corresponding to context information of flight is received, feature information is extracted from sensor data acquired by a sensor mounted on an unmanned aerial vehicle by using the identifier information, and the extracted feature information is transmitted to a server.

### BRIEF DESCRIPTION OF DRAWINGS

FIG. 1 illustrates an overview of a survey and inspection system to which a technology according to the present disclosure is applied.

FIG. 2 is a block diagram illustrating a configuration example of a drone.

FIG. 3 is a block diagram illustrating a configuration example of hardware of a cloud server.

FIG. 4 is a block diagram illustrating a functional configuration example of a cloud server.

FIG. 5 is a flowchart showing a flow of downloading identifier information.

FIG. 6 illustrates acquisition of context information.

FIG. 7 illustrates transmission of flight plan information and an identifier.

FIG. 8 is a flowchart showing a flow of extracting and transmitting feature information.

FIG. 9 illustrates image capturing of a ground control point.

FIG. 10 illustrates transmission of feature information.

FIG. 11 illustrates an amount of information to be transmitted to a cloud server.

FIG. 12 is a flowchart showing an operation of a cloud server.

### MODE FOR CARRYING OUT THE INVENTION

Hereinafter, modes for carrying out the present disclosure (hereinafter, referred to as “embodiments”) will be described. Note that description will be provided in the following order.

1. Overview of Survey and Inspection System

2. Configurations of Drone and Cloud Server

3. Download of Identifier Information

4. Extraction and Transmission of Feature Information

5. Operation of Cloud Server

6. Others

<1. Overview of Survey and Inspection System>

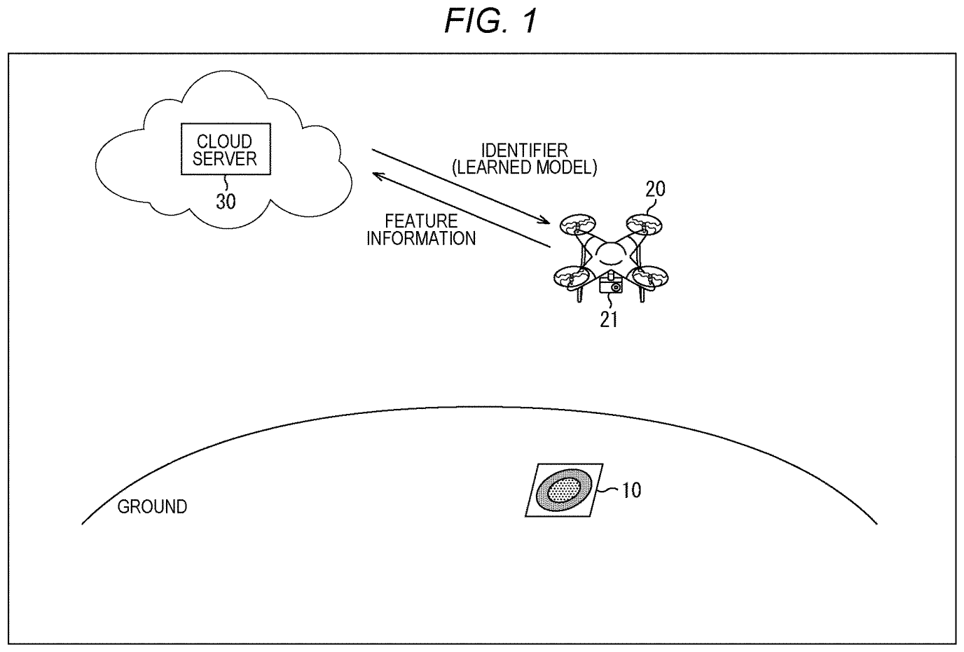

FIG. 1 illustrates an overview of a survey and inspection system to which a technology according to the present disclosure (the present technology) is applied.

In the survey and inspection system of FIG. 1, topographic surveys, inspection of structures, and the like are conducted by an unmanned aerial vehicle (UAV).

As illustrated in FIG. 1, a ground control point 10 is placed on the ground. The ground control point 10 is manually placed or is placed by, for example, being scattered from an unmanned aerial vehicle such as a drone or a flying vehicle such as an aircraft operated by a person. Further, the ground control point 10 may be placed on a top surface of a drone so that the ground control point 10 itself moves.

Note that, although not illustrated, a plurality of ground control points 10 is placed on the ground in a case where a topographic survey is conducted.

The ground control point 10 may be made from paper, plastic, or the like on which a predetermined pattern is printed, or may be made by overlapping a flat material such as plastic or rubber having a predetermined shape. Further, the ground control point 10 may include a display panel such as a liquid crystal display (LCD) or an organic electro luminescence (EL) display that displays a predetermined pattern, or may have a structure to be unfolded like a reflector, for example.

An image of the ground control point 10 is aerially captured. In the survey and inspection system of FIG. 1, a sensor 21 serving as, for example, a camera is mounted on a drone 20, and the drone 20 is flown to capture an image of the ground control point 10 (aerially capture an image of the ground control point 10) by using the sensor 21 mounted on the drone 20. The sensor 21 may be an RGB camera, an infrared camera, a multispectral camera, a stereo camera for distance measurement, or other sensors. Further, the sensor 21 may be mounted on the drone 20, may be detachable from the drone 20, or may be included in the drone 20.

A method of aerially capturing an image of the ground control point 10 is not limited to a method using the drone 20. That is, an image of the ground control point 10 may be aerially captured by using, for example, a flying vehicle on which a person boards and operates, an artificial satellite, or the like, instead of the unmanned aerial vehicle such as the drone 20.

A captured image (e.g., a still image) acquired by the sensor 21 capturing an image of the ground control point 10 is transmitted to, for example, a cloud server 30 via wireless communication or wired communication.

The cloud server 30 performs image processing on the captured image transmitted from the sensor 21 to extract feature information of the ground control point 10 appearing in the captured image, thereby identifying the ground control point 10. Further, the cloud server 30 creates a three-dimensional model of topography of the ground by using the captured image transmitted from the sensor 21 and a result of identification (feature information) of the ground control point 10. Then, the cloud server 30 conducts a topographic survey of the ground on the basis of the created three-dimensional model and outputs a result of the survey.

The processing performed by the cloud server 30 may be performed by the drone 20 instead of the cloud server 30, or may be shared between the drone 20 and the cloud server 30.

By the way, in a case where the drone 20 flies to sense a target and the cloud server 30 identifies the sensed target on the basis of a captured image transmitted from the drone 20 as described above, time taken to transmit the captured image and time taken to perform identification processing delay output of a final result.

Therefore, for example, in creation of a three-dimensional model of topography, it is possible to reduce throughput in the cloud server 30 if the drone 20 extracts feature information of the ground control point 10 appearing in a captured image acquired by the sensor 21 mounted on the drone 20.

Further, in recent years, performance of an identifier used for identifying the ground control point 10 has been improved by deep learning or the like.

Thus, in the survey and inspection system of the present technology, the drone 20 extracts feature information of the ground control point 10 from a captured image by edge computing in the drone 20 and transmits the feature information to the cloud server 30, thereby reducing throughput in the cloud server 30. This makes it possible to output a result of a topographic survey with less delay.

At this time, the drone 20 receives, from the cloud server 30, an identifier (learned model) suitable for a context such as a flight purpose or a flight environment of the drone, and extracts feature information of the ground control point 10 from a captured image. Therefore, the ground control point 10 serving as an identification target is more accurately identified.

<2. Configurations of Drone and Cloud Server>

Hereinafter, configurations of the drone 20 and the cloud server 30 included in the survey and inspection system of the present technology will be described.

(Configuration of Drone)

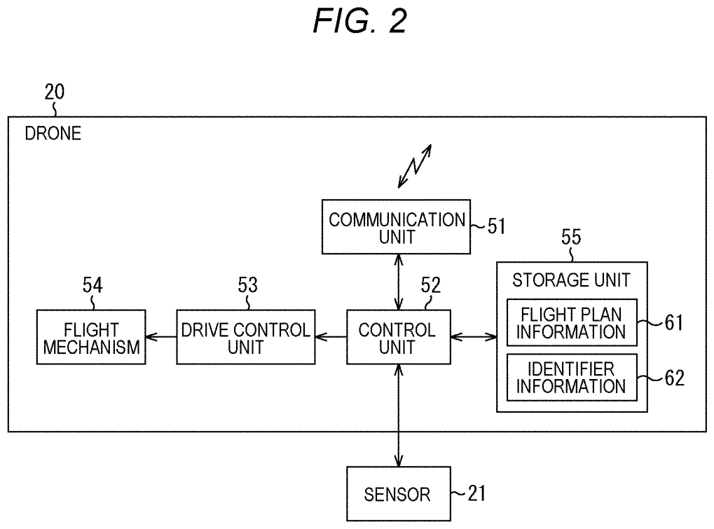

FIG. 2 is a block diagram illustrating a configuration example of the drone 20 of FIG. 1.

The drone 20 includes a communication unit 51, a control unit 52, a drive control unit 53, a flight mechanism 54, and a storage unit 55.

The communication unit 51 includes a network interface and the like, and performs wireless or wired communication with the cloud server 30, a controller for operating the drone 20, or any other device. The controller for operating the drone 20 includes a transmitter, a personal computer (PC), and the like. For example, the communication unit 51 may directly communicate with a communication partner device, or may perform network communication therewith via a base station and a relay, such as Wi-Fi (registered trademark), 4G, or 5G.

The control unit 52 includes a central processing unit (CPU), a memory, and the like, and controls the communication unit 51, the drive control unit 53, and the sensor 21 by executing a predetermined program.

The drive control unit 53 includes a circuit such as a dedicated IC or a field-programmable gate array (FPGA), and controls drive of the flight mechanism 54 under the control of the control unit 52.

The flight mechanism 54 is a mechanism for flying the drone 20, and includes, for example, a motor, a propeller, and the like. The flight mechanism 54 is driven under the control of the drive control unit 53 to fly the drone 20.

In the drone 20, the control unit 52 controls the drive control unit 53 according to, for example, a signal transmitted from the controller and received by the communication unit 51, thereby driving the flight mechanism 54. Thus, the drone 20 flies according to operation of the controller.

Further, the control unit 52 controls the sensor 21 according to a signal transmitted from the controller to cause the sensor 21 to perform sensing, thereby acquiring sensor data.

The storage unit 55 includes, for example, a nonvolatile memory such as a flash memory, and stores various types of information. For example, the storage unit 55 stores flight plan information 61 indicating a flight plan regarding flight performed by the drone 20 and identifier information 62 regarding an identifier corresponding to context information of the flight, both of which are downloaded from the cloud server 30. Details of the context information of the flight will be described later.

On the basis of the flight plan information 61 stored in the storage unit 55, the control unit 52 controls the drive control unit 53 so that the drone 20 flies according to a flight plan indicated by the flight plan information 61. Further, the control unit 52 extracts feature information from the sensor data acquired by the drone 20 by using, among pieces of the identifier information 62 stored in the storage unit 55, the identifier information 62 corresponding to the flight plan indicated by the flight plan information 61. Specifically, the control unit 52 extracts feature information by using the identifier information 62 from a captured image acquired by image capturing using the sensor 21 serving as a camera. The extracted feature information is transmitted from the communication unit 51 to the cloud server 30. Note that the feature information may be extracted from sensor data acquired by an infrared camera, a stereo camera for distance measurement, a distance sensor, or the like in the drone 20.

(Configuration of Cloud Server)

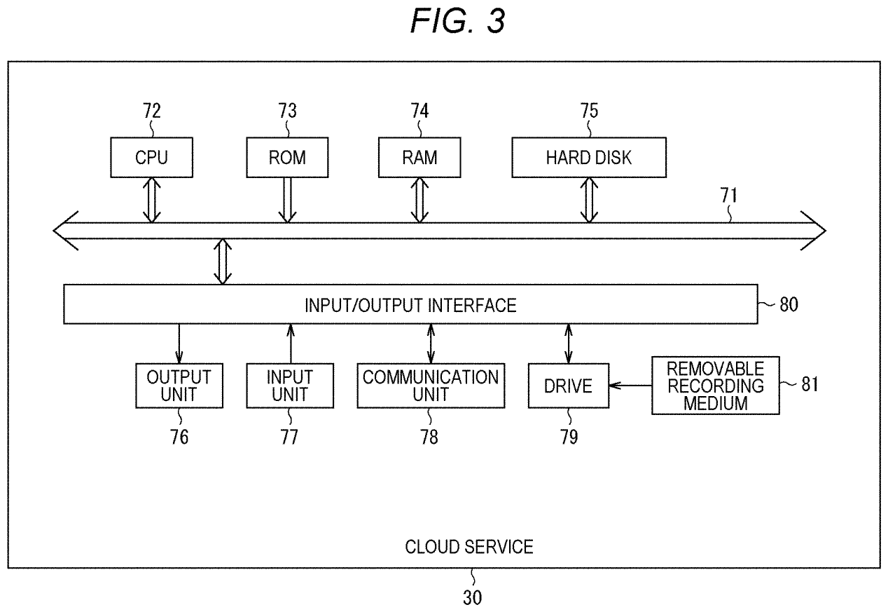

FIG. 3 is a block diagram illustrating a configuration example of hardware serving as an information processing device of the cloud server 30 of FIG. 1.

The cloud server 30 includes a CPU 72, and the CPU 72 is connected to an input/output interface 80 via a bus 71.

In a case where, for example, a user (operator) operates an input unit 77 to input a command to the CPU 72 via the input/output interface 80, the CPU 72 executes a program stored in a read only memory (ROM) 73 according to the command. Further, the CPU 72 loads a program stored in a hard disk 75 into a random access memory (RAM) 34 and executes the program.

The CPU 72 performs various types of processing to cause the cloud server 30 to function as a device having a predetermined function. The CPU 72 causes an output unit 76 to output results of the various types of processing, causes a communication unit 78 to transmit the processing results, or causes the hard disk 75 to record the processing results via, for example, the input/output interface 80, as necessary.

The input unit 77 includes a keyboard, a mouse, a microphone, and the like. The output unit 76 includes an LCD, a speaker, and the like.

The programs executed by the CPU 72 can be recorded in advance on the hard disk 75 or the ROM 73 serving as a built-in recording medium of the cloud server 30 or on a removable recording medium 81.

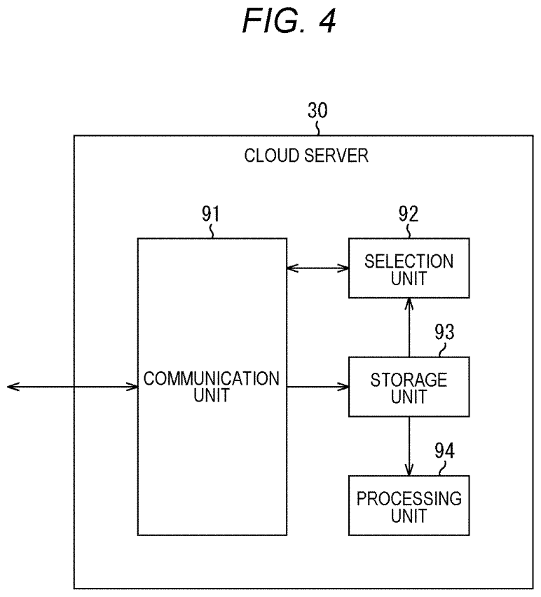

FIG. 4 is a block diagram illustrating a functional configuration example of the cloud server 30.

As illustrated in FIG. 4, the cloud server 30 includes a communication unit 91, a selection unit 92, a storage unit 93, and a processing unit 94.

The communication unit 91 corresponds to the communication unit 78 in FIG. 3, and performs wireless or wired communication with the drone 20.

The selection unit 92 is realized by the CPU 72 executing a program, and selects an identifier corresponding to context information of flight performed by the drone 20 from a plurality of identifiers stored in the storage unit 93. The context information is transmitted from the drone 20 to be received by the communication unit 91 or is directly acquired by the cloud server 30.

The storage unit 93 corresponds to, for example, the hard disk 75 in FIG. 3 or the like, and stores various types of data and information such as a plurality of pieces of flight plan information, identifiers and pieces of identifier information corresponding thereto, and feature information extracted from a captured image and transmitted from the drone 20. The data and information stored in the storage unit 93 are appropriately used for processing performed by the processing unit 94.

The processing unit 94 is realized by the CPU 72 executing a program, and performs processing by using the data and information stored in the storage unit 93.

<3. Download of Identifier Information>

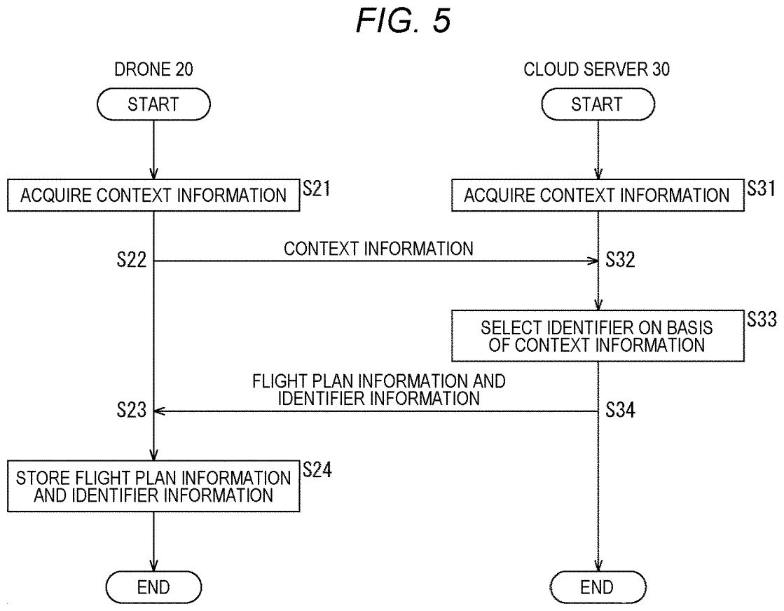

Here, a flow of downloading identifier information in the survey and inspection system of FIG. 1 will be described with reference to a flowchart of FIG. 5. Processing in FIG. 5 is executed, for example, before the drone 20 starts flying.

When the drone 20 acquires context information of flight in step S21, the communication unit 51 of the drone 20 transmits the acquired context information to the cloud server 30 in step S22.

The drone 20 may acquire information input by the user as the context information or may acquire the context information from an external device.

The context information includes at least information indicating a flight environment of the drone 20 and information indicating a flight plan regarding flight performed by the drone 20. The information indicating a flight environment of the drone 20 includes position information, time information, weather information, and the like of the drone 20. Further, the information indicating a flight plan of the drone 20 includes a flight path, a flight purpose, a sensing target, time information regarding sensing flight of the drone 20, and the like.

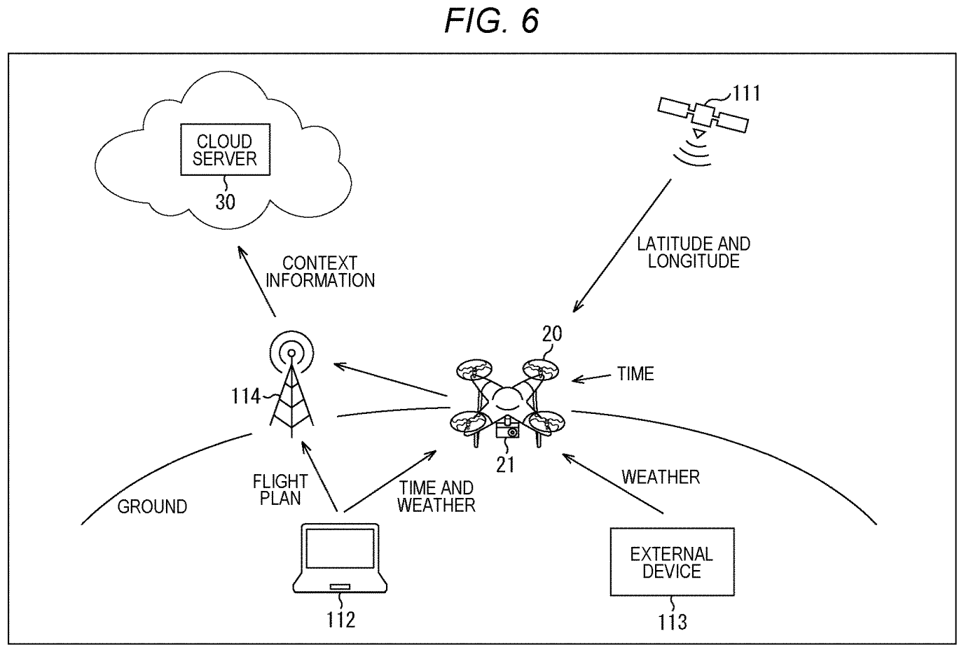

As illustrated in FIG. 6, for example, the communication unit 51 receives a global positioning system (GPS) signal transmitted from a GPS satellite 111, and thus the drone 20 acquires, as the information indicating a flight environment, position information indicating a latitude and a longitude of the drone.

Further, the drone 20 acquires time information and weather information as the information indicating a flight environment from a controller 112 including a PC.

The time information indicates a current time clocked by a clocking unit in the controller 112. The time information does not need to indicate time in minutes, and may indicate, for example, a period of time such as time in hours or may include date information indicating a year, month, and day. Further, the time information may be acquired from a clocking unit in the drone 20.

The weather information indicates, for example, weather at a flight site input by the user to the controller 112. The weather information may include wind speed information indicating a wind speed at the flight site and wind direction information indicating a wind direction. Further, the weather information may be acquired from an external device 113 that provides weather information directly or via the controller 112.

The flight purpose included in the flight plan includes details of a mission such as a topographic survey of the ground or inspection of a structure. Inspection of a structure includes, for example, detecting damage to a solar panel installed on the ground, detecting a crack or tile peeling of an outer wall of, for example, an architectural structure such as a building, and the like. Further, the flight purpose may include investigation for a growth state of crops, presence or absence of diseases, harmful insects, and the like, transportation of articles, and the like. Furthermore, the sensing target included in the flight plan is the ground control point 10 corresponding to the flight purpose, an inspection point of a structure, a point where a crop grows or has a disease, an article to be transported, or the like.

The flight path included in the flight plan is indicated by a flight altitude, a flight path (waypoint), or the like at/through which the drone 20 flies to achieve the flight purpose described above. Further, the time information regarding sensing flight indicates a scheduled start time, a scheduled end time, or the like of the sensing flight.

The information indicating a flight plan described above is input to the controller 112 by, for example, the user and is transmitted to the cloud server 30 as the context information via a base station 114 installed on the ground or directly from another device. Further, the information indicating a flight plan serving as the context information may be set in the drone 20 in advance and be transmitted from the drone 20 to the cloud server 30 via the base station 114.

Meanwhile, the information indicating a flight environment acquired by the drone 20, such as the time information and the weather information, is transmitted as the context information to the cloud server 30 via the base station 114 installed on the ground.

Returning to the flowchart of FIG. 5, the communication unit 91 of the cloud server 30 directly acquires the context information in step S31, and receives the context information from the drone 20 in step S32.

Thereafter, in step S33, the selection unit 92 of the cloud server 30 selects, from a plurality of identifiers stored in the storage unit 93, an identifier corresponding to the context information (flight plan) acquired by the cloud server 30 and the context information (flight environment) transmitted from the drone 20.

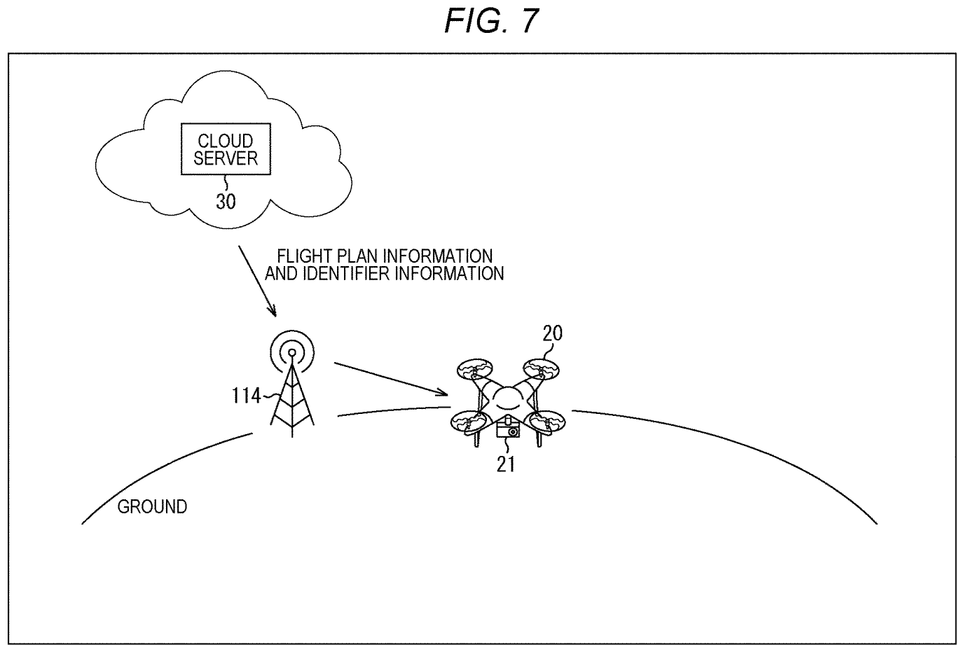

In step S34, as illustrated in FIG. 7, the communication unit 91 of the cloud server 30 transmits flight plan information indicating the flight plan included in the context information and identifier information of the identifier selected corresponding to the flight plan to the drone 20 via the base station 114. The flight plan information includes a flight path, a flight purpose, a sensing target, time information regarding sensing flight, and the like. Note that the identifier information may be included in the flight plan information.

In step S23, the communication unit 51 of the drone 20 receives the flight plan information and the identifier information from the cloud server 30.

Thereafter, in step S24, the control unit 52 of the drone 20 stores the flight plan information and the identifier information transmitted from the cloud server 30 in the storage unit 55.

The identifier includes a module and a parameter. The module is the identifier itself, and is defined for, for example, each type such as a flight purpose (a mission such as a topographic survey or inspection of a structure). The parameter is optimized by being adjusted for each piece of the context information to correspond to each type of identifier.

For example, for a module for a topographic survey, parameters optimized for position information, time information, and weather information at the time are used. Further, for example, for a module for detecting damage to a solar panel, not only parameters optimized for position information, time information, and weather information at the time but also parameters optimized for a manufacturer of the solar panel and the like are used.

For example, the module is an object in which a source code is built, and the parameter is information read into the object at or during activation of the object. Further, the module may include default values of the parameters.

The identifier information may be information forming the identifier itself (module and parameter) or may be information specifying the identifier. The information specifying the identifier may include an ID and version information of the identifier. Further, the information specifying the identifier may include information indicating the type of identifier according to the flight purpose (a mission such as a topographic survey or inspection of a structure).

Therefore, in the processing described above, either one or both of the parameter and the module of the identifier may be transmitted to the drone 20 as the identifier information. Further, only the information specifying the identifier may be transmitted to the drone 20 as the identifier information.

For example, in a case where the drone 20 holds a module of a specific type in advance, only a parameter corresponding to the module is transmitted to the drone 20. Further, in a case where the drone 20 holds a plurality of types of modules in advance, type information indicating the type of module and a parameter corresponding to the module of the type may be transmitted to the drone 20. Furthermore, in a case where the drone 20 holds modules and parameters corresponding to the modules in advance, only information specifying a required module and parameter is transmitted to the drone 20.

<4. Extraction and Transmission of Feature Information>

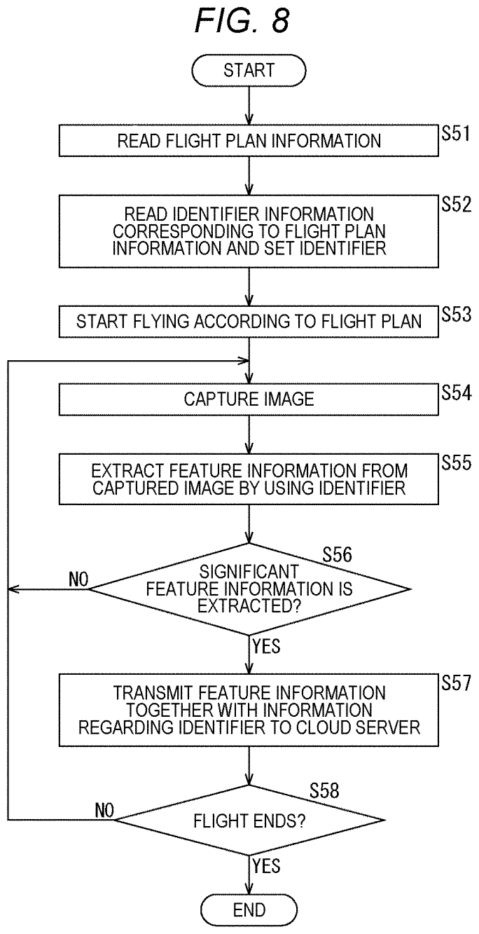

Next, a flow of extracting and transmitting feature information in the flying drone 20 will be described with reference to a flowchart of FIG. 8.

In step S51, the control unit 52 reads flight plan information stored in the storage unit 55.

In step S52, the control unit 52 reads identifier information corresponding to the read flight plan information from the storage unit 55, thereby setting an identifier used for extracting feature information.

When the identifier is set, in step S53, the control unit 52 controls the drive control unit 53 on the basis of the flight plan information, thereby causing the drone 20 to start flying according to a flight plan indicated by the flight plan information.

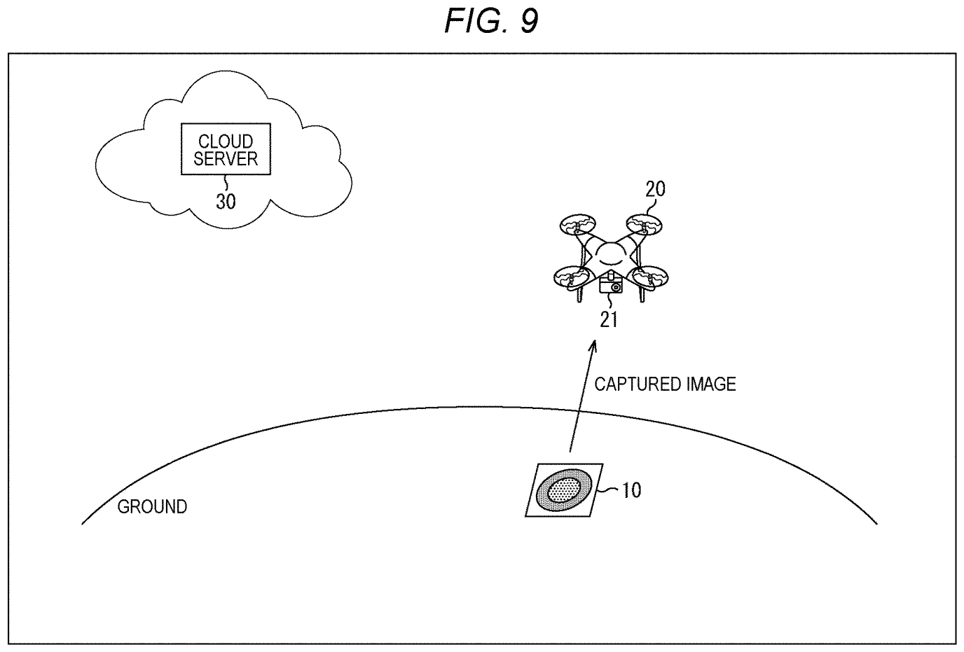

In step S54, the sensor 21 mounted on the flying drone 20 captures (aerially captures) an image of the ground as illustrated in FIG. 9. The captured image acquired by image capturing using the sensor 21 is supplied to the control unit 52.

In step S55, the control unit 52 identifies a subject (sensing target) appearing in the captured image by using the set identifier and thus extracts feature information from the captured image. As described above, the control unit 52 performs sensing using the identifier corresponding to the flight plan by controlling the sensor 21 while the drone 20 is flying.

In step S56, the control unit 52 determines whether or not significant feature information has been extracted on the basis of the identifier.

For example, in a case where the ground control point 10 is identified as a sensing target appearing in the captured image and feature information regarding the ground control point 10 is extracted, it is determined that significant feature information has been extracted. For example, position information of the ground control point 10 is extracted as the feature information regarding the ground control point 10.

Further, in a case where damage to a solar panel is identified as a sensing target appearing in the captured image and feature information regarding the damage to the solar panel is extracted, it may be determined that significant feature information has been extracted.

In a case where it is determined in step S56 that significant feature information has been extracted, the process proceeds to step S57.

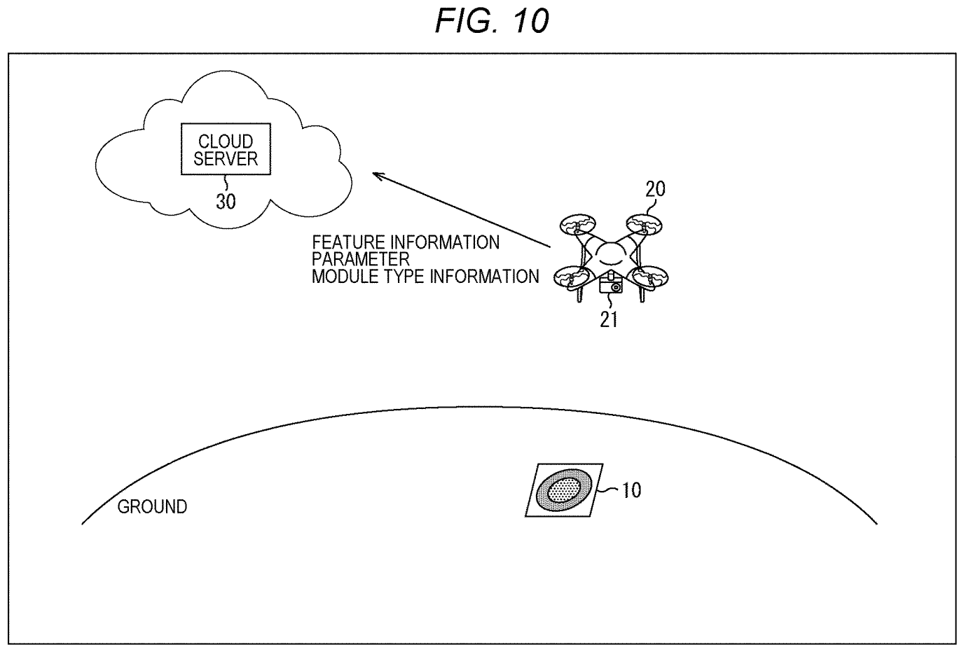

In step S57, under the control of the control unit 52, the communication unit 51 transmits the extracted feature information together with information regarding the identifier used for the extraction to the cloud server 30. The information regarding the identifier may be information forming the identifier (module and parameter) or may be information specifying the identifier. For example, as illustrated in FIG. 10, a parameter of the identifier used for extracting the feature information and type information indicating the type of module of the identifier (type for each flight purpose) are added to the feature information as, for example, header information and are transmitted to the cloud server 30. Further, as the information regarding the identifier used for extracting the feature information, the module itself may be transmitted to the cloud server 30 separately from the feature information, instead of the type information of the module, or all identification results may be transmitted to the cloud server 30. Furthermore, as the information regarding the identifier used for extracting the feature information, an ID and version information of the identifier and information indicating the type of identifier corresponding to the sensing target serving as an identification target may be transmitted to the cloud server 30.

In addition, as the feature information, not only position information of the sensing target but also information specifying the sensing target may be extracted from the captured image and be transmitted to the cloud server 30. For example, as the information specifying the sensing target, an ID of the sensing target given by the identifier and the type of the sensing target, such as the ground control point 10, an inspection point of a structure, a point where a crop grows or has a disease, an article to be transported, or the like, may be extracted. Further, as the information specifying the sensing target, a state of the sensing target may be extracted, such as presence or absence of abnormality of the ground control point 10, the type of damage to a structure, and presence or absence of diseases and harmful insects of crops. Furthermore, as the information specifying the sensing target, a partial image in which the sensing target appears may be extracted, such as an image of a part of the captured image in which only the sensing target appears or an image of a predetermined range including the sensing target.

Still further, not only the feature information and the information regarding the identifier used for the extraction but also sensing data (e.g., the captured image) itself obtained by sensing may be transmitted to the cloud server 30 depending on the flight purpose such as, for example, a topographic survey using a three-dimensional model. The sensing data to be transmitted to the cloud server 30 may include, for example, not only the captured image obtained by capturing an image of the sensing target but also a captured image obtained by capturing an image of another range. The sensing data may be an image of a specific wavelength acquired by an RGB camera or an infrared camera, or may be data obtained by indexing an image by predetermined calculation, such as the normalized difference vegetation index (NDVI). Further, in a case where the flight purpose is to detect a structure such as a topographic survey, the sensing data may include depth information like three-dimensional data such as point cloud data.

After the feature information and the like are transmitted to the cloud server 30, in step S58, the control unit 52 determines whether or not the flight according to the flight plan indicated by the flight plan information ends.

In a case where it is determined in step S58 that the flight according to the flight plan does not end yet, or in a case where it is determined in step S56 that significant feature information has not been extracted, the process returns to step S54, and similar processing is repeated at regular time intervals.

Meanwhile, in a case where it is determined in step S58 that the flight according to the flight plan ends, the control unit 52 causes the drive control unit 53 to terminate the flight of the drone 20.

In this way, the drone 20 aerially captures an image of the ground, extracts feature information from the acquired captured image, and transmits the feature information to the cloud server 30 at intervals of, for example, several minutes or the like during flight according to a flight plan after starting the flight.

According to the above processing, sensing using an identifier corresponding to a flight plan is performed during flight according to a flight plan. That is, the drone 20 can more accurately identify the ground control point 10 serving as an identification target because the drone 20 extracts feature information of the ground control point 10 from a captured image by using the identifier suitable for the flight plan.

For example, even in a case where the drone 20 is flown for a topographic survey of the ground as a flight purpose and is then flown for detecting damage to a solar panel as another flight purpose, it is possible to accurately identify an identification target for each flight purpose by using an identifier suitable for each flight purpose.

Further, the drone 20 can more accurately identify the ground control point 10 serving as an identification target because the drone 20 extracts feature information of the ground control point 10 from a captured image by using an identifier suitable for a flight environment of the drone.

For example, in some cases, the ground control point 10 cannot be accurately identified depending on a degree of sunlight falling on the ground control point 10. The degree of sunlight varies depending on a place, time, and weather in which the drone 20 flies.

Therefore, by using an identifier corresponding to context information indicating a place, time, and weather in which the drone 20 flies, it is possible to accurately identify the ground control point 10 without being affected by the degree of sunlight.

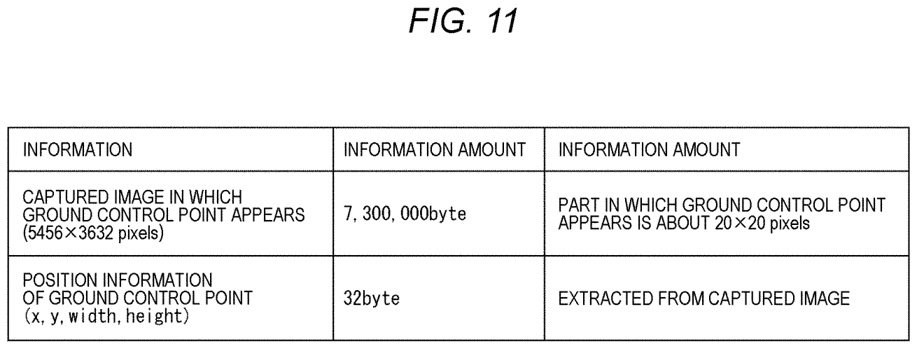

FIG. 11 illustrates an amount of information to be transmitted to the cloud server 30.

For example, in a case where the information to be transmitted to the cloud server 30 is a captured image of 5456×3632 pixels in which the ground control point 10 appears, an amount of the information is 7,300,000 bytes (7.3 MB). However, in the captured image, a part (area) in which the ground control point 10 appears is about 20×20 pixels.

Meanwhile, in a case where the information to be transmitted to the cloud server 30 is position information of the ground control point 10 (a coordinate position of the ground control point 10 on an xy plane, width and height of the ground control point 10) extracted as feature information from a captured image in which the ground control point 10 appears, an amount of the information is 32 bytes.

For example, in a case where the flight purpose does not require that the captured image itself be transmitted to the cloud server 30, it is possible to reduce an amount of the information to be transmitted to the cloud server 30 by extracting feature information from the aerially captured image as described above.

Note that the context information may include information regarding a version of the identifier. For example, the drone 20 transmits, as the context information, information requesting the latest version of a parameter of an identifier corresponding to a topographic survey to the cloud server 30, with the result that identification accuracy of the ground control point 10 can be improved.

Further, the feature information extracted from the captured image is transmitted to the cloud server 30 during flight, and, in addition, the captured image in which the ground control point 10 appears may be transmitted to the cloud server 30 via, for example, wired communication while the drone 20 is on the ground after the flight ends.

<5. Operation of Cloud Server>

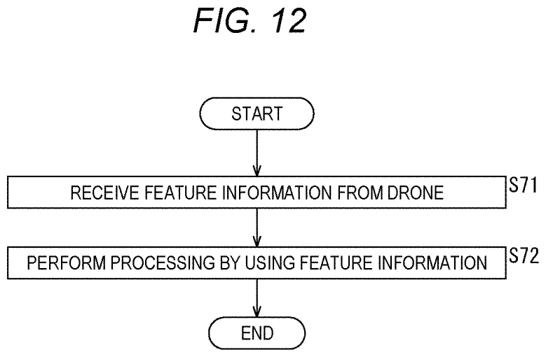

Next, an operation of the cloud server 30 after the feature information is transmitted from the drone 20 will be described with reference to a flowchart of FIG. 12.

In step S71, the communication unit 91 receives the feature information from the drone 20 and stores the feature information in the storage unit 93.

In step S72, the processing unit 94 performs processing by using the feature information stored in the storage unit 93.

For example, the processing unit 94 creates a three-dimensional model of topography of the ground by using the feature information (position information) of the ground control point 10 transmitted from the drone 20. Then, the processing unit 94 conducts a topographic survey of the ground on the basis of the created three-dimensional model, and outputs a result of the survey via the communication unit 91.

Note that information that is added as header information of the feature information and forms an identifier, such as a parameter of the identifier used for extracting the feature information, and information regarding the identifier used for extracting the feature information, such as type information of a module (identifier) and an ID and version information of the identifier, can be used to verify the identifier.

Specifically, for example, whether or not the parameter used for extracting the feature information is an optimal parameter and whether or not the module used for extracting the feature information is a module of a correct type are verified. Further, in a case where some parameters have not been transmitted due to interruption of communication or the like during transmission of an identifier to the drone 20, it is possible to verify which parameters have not been transmitted.

Those verifications may be executed by the processing unit 94, and results of the verifications may be output to the outside as an alert. Further, in a case where the context information is transmitted from the drone 20, an identifier corresponding to the context information may be selected on the basis of the results of the verifications.

Furthermore, the processing unit 94 may perform not only the verification processing described above but also comparison processing as to whether or not the identifier information corresponding to the flight plan information transmitted from the cloud server 30 to the drone 20 matches the information regarding the identifier used for extracting the feature information.

<6. Others>

### Modification Examples

In the above description, the identifier is downloaded before the drone 20 starts flying, but may be downloaded during flight. Therefore, the drone 20 can perform different missions in one flight.

For example, when the drone 20 in which an identifier for a topographic survey has been set starts flying and finishes aerially capturing an image for the topographic survey, an identifier for inspecting a structure according to a flight environment at the time is downloaded to the drone 20 during flight. This makes it possible to continuously perform aerial image capturing for a topographic survey and aerial image capturing for inspecting a structure in one flight.

### Application Examples

The present technology is also applicable to moving objects other than an unmanned aerial vehicle such as a drone.

For example, the present technology may be applied to automatic driving vehicles such as automobiles, trains, and new transportation systems. In this case, an identifier suitable for a running environment is downloaded to a vehicle, thereby improving recognition accuracy of other vehicles, people, signals, and the like in an image captured while running.

Further, the present technology may be applied to a robot vacuum cleaner. In this case, an identifier suitable for a cleaning environment is downloaded to the robot vacuum cleaner, thereby improving recognition accuracy of obstacles in an image captured while running.

The series of processing described above can be executed by hardware or can be executed by software. In a case where the series of processing is executed by software, a program forming the software is installed from a network or a program recording medium.

Embodiments of the technology according to the present disclosure are not limited to the above embodiments, and can be variously modified without departing from the gist of the technology according to the present disclosure.

Further, the effects described in this specification are merely examples, are not limited, and additional effects may be obtained.

Furthermore, the technology according to the present disclosure can have the following configurations.

(1)

An unmanned aerial vehicle serving as an unmanned aircraft, including:

a control unit that extracts feature information from sensor data acquired by a sensor mounted on the unmanned aircraft; and

a communication unit that transmits the extracted feature information to a server,

in which:

the communication unit receives identifier information regarding an identifier corresponding to context information of flight; and

the control unit extracts the feature information from the sensor data by using the identifier information.

(2)

The unmanned aerial vehicle according to (1), in which

the communication unit

transmits the context information to the server, and

receives the identifier information of the identifier selected by the server on the basis of the context information.

(3)

The unmanned aircraft according to (1) or (2), in which

the context information includes at least information indicating a flight plan regarding flight performed by the unmanned aircraft and information indicating a flight environment of the unmanned aircraft.

(4)

The unmanned aircraft according to (3), in which

the communication unit receives flight plan information indicating the flight plan and the identifier information corresponding to the flight plan.

(5)

The unmanned aircraft according to (4), in which

the control unit performs sensing using the identifier corresponding to the flight plan by controlling the sensor during flight according to the flight plan.

(6)

The unmanned aerial vehicle according to any one of (3) to (5), in which

the information indicating a flight environment includes at least one of position information, time information, or weather information of the unmanned aircraft.

(7)

The unmanned aerial vehicle according to (6), in which

the position information indicates a latitude and a longitude.

(8)

The unmanned aerial vehicle according to (6), in which

the weather information includes wind speed information and wind direction information.

(9)

The unmanned aerial vehicle according to any one of (3) to (5), in which

the information indicating a flight plan includes at least one of a flight path, a flight purpose, a sensing target, or time information regarding sensing flight.

(10)

The unmanned aerial vehicle according to (9), in which

the flight path is indicated by a waypoint.

(11)

The unmanned aerial vehicle according to (9), in which

the flight purpose includes at least one of a topographic survey or inspection of a structure.

(12)

The unmanned aerial vehicle according to (9), in which

the sensing target includes at least one of a ground control point, a damaged part of a solar panel, or a cracked part or a tile peeling part of an outer wall of a building.

(13)

The unmanned aerial vehicle according to any one of (1) to (12), in which:

the sensor serves as a camera that captures an image during flight; and

the control unit extracts the feature information from a captured image acquired by image capturing using the camera.

(14)

The unmanned aerial vehicle according to (13), in which

the control unit extracts, as the feature information, information regarding a sensing target identified in the captured image.

(15)

The unmanned aerial vehicle according to (14), in which

the feature information includes at least one of position information of the sensing target or information specifying the sensing target.

(16)

The unmanned aerial vehicle according to any one of (1) to (15), in which

the communication unit receives, as the identifier information, at least one of information forming the identifier or information specifying the identifier from the server.

(17)

The unmanned aerial vehicle according to (16), in which

the communication unit transmits, to the server, the extracted feature information and information regarding the identifier used for extracting the feature information.

(18)

The unmanned aerial vehicle according to (17), in which

the information regarding the identifier includes at least one of the information forming the identifier or the information specifying the identifier.

(19)

A communication method including

causing an unmanned aerial vehicle to

receive identifier information regarding an identifier corresponding to context information of flight,

extract feature information by using the identifier information from sensor data acquired by a sensor mounted on the unmanned aircraft, and

transmit the extracted feature information to a server.

(20)

A program for causing a computer to execute the processing of

receiving identifier information regarding an identifier corresponding to context information of flight,

extracting feature information by using the identifier information from sensor data acquired by a sensor mounted on an unmanned aerial vehicle, and

transmitting the extracted feature information to a server.

(21)

An information processing device including:

a communication unit that receives context information of flight of an unmanned aerial vehicle;

and

a selection unit that selects an identifier corresponding to the context information on the basis of the context information,

in which

the communication unit transmits identifier information regarding the selected identifier to the unmanned aerial vehicle.

(22)

The information processing device according to (21), in which:

the communication unit receives feature information extracted by using the identifier information from sensor data acquired by a sensor mounted on the unmanned aerial vehicle; and

the information processing device further includes a storage unit that stores the received feature information.

(23)

The information processing device according to (22), in which:

the communication unit receives, from the unmanned aerial vehicle, the extracted feature information and information regarding the identifier used for extracting the feature information; and

the storage unit stores the received feature information and the information regarding the identifier.

(24)

The information processing device according to (23), in which

the information regarding the identifier includes at least one of information forming the identifier or information specifying the identifier.

(25)

The information processing device according to (23) or (24), further including

a processing unit that verifies the identifier by using the information regarding the identifier.

### REFERENCE SIGNS LIST

10 Ground control point
20 Drone
21 Camera
30 Cloud server
51 Communication unit
52 Control unit
53 Drive control unit
54 Flight mechanism
55 Storage unit
61 Flight plan information
62 Identifier information
91 Communication unit
92 Selection unit
93 Storage unit
94 Processing unit

1. An unmanned aerial vehicle serving as an unmanned aircraft, comprising:
a control unit that extracts feature information from sensor data acquired by a sensor mounted on the unmanned aircraft; and
a communication unit that transmits the extracted feature information to a server,
wherein:
the communication unit receives identifier information regarding an identifier corresponding to context information of flight; and
the control unit extracts the feature information from the sensor data by using the identifier information.

2. The unmanned aerial vehicle according to claim 1, wherein
the communication unit
transmits the context information to the server, and
receives the identifier information of the identifier selected by the server on a basis of the context information.

3. The unmanned aircraft according to claim 2, wherein
the context information includes at least information indicating a flight plan regarding flight performed by the unmanned aircraft and information indicating a flight environment of the unmanned aircraft.

4. The unmanned aircraft according to claim 3, wherein
the communication unit receives flight plan information indicating the flight plan and the identifier information corresponding to the flight plan.

5. The unmanned aircraft according to claim 4, wherein
the control unit performs sensing using the identifier corresponding to the flight plan by controlling the sensor during flight according to the flight plan.

6. The unmanned aerial vehicle according to claim 3, wherein
the information indicating a flight environment includes at least one of position information, time information, or weather information of the unmanned aircraft.

7. The unmanned aerial vehicle according to claim 6, wherein
the position information indicates a latitude and a longitude.

8. The unmanned aerial vehicle according to claim 6, wherein
the weather information includes wind speed information and wind direction information.

9. The unmanned aerial vehicle according to claim 3, wherein
the information indicating a flight plan includes at least one of a flight path, a flight purpose, a sensing target, or time information regarding sensing flight.

10. The unmanned aerial vehicle according to claim 9, wherein
the flight path is indicated by a waypoint.

11. The unmanned aerial vehicle according to claim 9, wherein
the flight purpose includes at least one of a topographic survey or inspection of a structure.

12. The unmanned aerial vehicle according to claim 9, wherein
the sensing target includes at least one of a ground control point, a damaged part of a solar panel, or a cracked part or a tile peeling part of an outer wall of a building.

13. The unmanned aerial vehicle according to claim 1, wherein:
the sensor serves as a camera that captures an image during flight; and
the control unit extracts the feature information from a captured image acquired by image capturing using the camera.

14. The unmanned aerial vehicle according to claim 13, wherein
the control unit extracts, as the feature information, information regarding a sensing target identified in the captured image.

15. The unmanned aerial vehicle according to claim 14, wherein
the feature information includes at least one of position information of the sensing target or information specifying the sensing target.

16. The unmanned aerial vehicle according to claim 1, wherein
the communication unit receives, as the identifier information, at least one of information forming the identifier or information specifying the identifier from the server.

17. The unmanned aerial vehicle according to claim 16, wherein
the communication unit transmits, to the server, the extracted feature information and information regarding the identifier used for extracting the feature information.

18. The unmanned aerial vehicle according to claim 17, wherein
the information regarding the identifier includes at least one of the information forming the identifier or the information specifying the identifier.

19. A communication method comprising
causing an unmanned aerial vehicle to
receive identifier information regarding an identifier corresponding to context information of flight,
extract feature information by using the identifier information from sensor data acquired by a sensor mounted on the unmanned aircraft, and
transmit the extracted feature information to a server.

20. A program for causing a computer to execute the processing of
receiving identifier information regarding an identifier corresponding to context information of flight,
extracting feature information by using the identifier information from sensor data acquired by a sensor mounted on an unmanned aerial vehicle, and
transmitting the extracted feature information to a server.
